(19) United States
(12) Patent Application Publication
(10) Pub. No.: US 2013/0135977 A1
(43) Pub. Date: May 30, 2013

(54) OPTICAL PICKUP APPARATUS

(71) Applicants: Hajime IIZUKA, Tatebayashi-shi (JP); Satoshi SEKIGUCHI, Oizumi-Machi (JP)

(72) Inventors: Hajime IIZUKA, Tatebayashi-shi (JP); Satoshi SEKIGUCHI, Oizumi-Machi (JP)

(21) Appl. No.: 13/676,594

(22) Filed: Nov. 14, 2012

(30) Foreign Application Priority Data
Nov. 25, 2011 (JP) 2011-257975

(51) Int. Cl. G11B 7/1263

(52) U.S. Cl. CPC G11B 7/1263
USPC 369/53.26

(57) ABSTRACT

An optical-pickup apparatus includes: a first laser-light source to emit a first laser beam to a first optical disc; a first photodetector to output a first monitor signal indicative of intensity of the first laser beam; a second laser-light source to emit a second laser beam to a second optical disc; a second photodetector to output a second monitor signal indicative of intensity of the second laser beam; a signal-selection unit to select the first monitor signal when recording or reading of information is performed for the first optical disc, and select the second monitor signal when recording or reading of information is performed for the second optical disc; and a signal-transmission unit to transmit, via a common transmission path, the first monitor signal or the second monitor signal selected by the single-selection unit to a control circuit configured to control intensity of the first laser and second laser beams.

### CROSS-REFERENCE TO RELATED APPLICATION

This application claims the benefit of priority to Japanese Patent Application No. 2011-257975, filed Nov. 25, 2011, of which full contents are incorporated herein by reference.

### BACKGROUND OF THE INVENTION

1. Field of the Invention

The present invention relates to an optical pickup apparatus configured to record/read signals into/from an optical disc.

2. Description of the Related Art

An optical pickup apparatus has been developed that is capable of reading and recording of signals by collecting a laser beam onto a signal recording layer of an optical disc.

Red beam having a wavelength of 650 nm, for example, is used as a laser beam for performing reading and recording of signals with respect to a DVD (Digital Versatile Disc) standard optical disc, and infrared light having a wavelength of 780 nm, for example, is used as a laser beam for performing reading and recording of signals with respect to a CD (Compact Disc) standard optical disc.

Other than such CD standard and DVD standard optical discs, blue-violet light having a wavelength of 405 nm, for example, is used as a laser beam for performing reading and recording of signals with respect to a Blu-ray (registered trademark, the same applies hereinafter) standard optical disc.

An optical pickup apparatus has been developed capable of recording and reading of information with respect to any of such optical discs as DVD, CD, and Blu-ray discs (See Japanese Unexamined Patent Application Publication No. 2006-120306, for example).

Such an optical pickup apparatus is configured including a first laser unit capable of selectively emitting laser beams for DVD and for CD and a second laser unit capable of emitting a laser beam for Blu-ray, separately, due to difference in intensity of the laser beams and the like. In such a configuration, the intensity of each of the laser beams is controlled as follows.

First, in the case of the laser beam for DVD and the laser beam for CD, a portion of the laser beam emitted from the first laser unit to the optical disc is separated, and guided to a photodetector for DVD and CD. When the laser beam is detected in this photodetector, a monitor signal according to detected intensity thereof is outputted from this photodetector. Then, this monitor signal is inputted to a control circuit of the optical pickup apparatus. This control circuit outputs a control signal to a driving circuit of the first laser unit in accordance with the monitor signal so that the intensity of the laser beam emitted from the first laser unit reaches a predetermined target value. Then, the first laser unit emits the laser beam having intensity according to the driving signal outputted from this driving circuit. As such, the intensity of the laser beam emitted from the first laser unit is controlled.

In the case of the laser beam for Blu-ray, a portion of the laser beam emitted from the second laser unit to the optical disc is separated and guided to a photodetector for Blu-ray. When the laser beam is detected in this photodetector, a monitor signal according to detected intensity thereof is outputted from this photodetector. Then, this monitor signal is inputted to the control circuit of the optical pickup apparatus. This control circuit outputs a control signal to a driving circuit of the second laser unit in accordance with the monitor signal so that the intensity of the laser beam emitted from the second laser unit reaches a predetermined target value. Then, the second laser unit emits the laser beam having intensity according to the driving signal outputted from this driving circuit. As such, the intensity of the laser beam for Blu-ray emitted from the second laser unit is controlled.

As described above, in the case of the optical pickup apparatus capable of recording and reading of information with respect to any of such optical discs as DVD, CD, and Blu-ray, in addition to the monitor signal indicating the detected intensity of the laser beam emitted from the first laser unit, the monitor signal indicating the detected intensity of the laser beam emitted from the second laser unit is also transmitted to the control circuit from the optical pickup apparatus.

Transmission of various signals from the optical pickup apparatus to the control circuit and from the control circuit to the optical pickup apparatus is performed through a transmission path electrically connected by a connector, but the number of transmission paths which can be connected to this connector is restricted by the number of pins in the connector.

Therefore, the number of transmission paths increases with an increase in the number of signals that should be sent/received between the optical pickup apparatus and the control circuit, and if the number of pins in the connector is insufficient, a larger-sized connector having more pins needs to be used.

Thus, a technique to reduce the number of transmission paths between the optical pickup apparatus and the control circuit is in demand.

### SUMMARY OF THE INVENTION

An optical pickup apparatus according to an aspect of the present invention, includes: a first laser light source configured to emit a first laser beam to a first optical disc to which the first laser beam having a first wavelength conforms; a first photodetector configured to detect intensity of the first laser beam emitted from the first laser light source and output a first monitor signal indicative of intensity of the first laser beam; a second laser light source configured to emit a second laser beam to a second optical disc to which the second laser beam having a second wavelength different from the first wavelength conforms; a second photodetector configured to detect intensity of the second laser beam emitted from the second laser light source and output a second monitor signal indicative of intensity of the second laser beam; a signal selection unit configured to select the first monitor signal when recording or reading of information is performed for the first optical disc, and select the second monitor signal when recording or reading of information is performed for the second optical disc; and a signal transmission unit configured to transmit, via a common transmission path, the first monitor signal or the second monitor signal selected by the single selection unit to a control circuit configured to control intensity of the first laser beam emitted from the first laser light source and the second laser beam emitted from the second laser light source.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is an entire configuration diagram of an optical pickup apparatus according to an embodiment of the present invention;

FIG. 2 is a configuration diagram of a laser output detection circuit according to an embodiment of the present invention;

FIG. 3A is a diagram for describing a waveform of an output signal from a laser output detection circuit according to an embodiment of the present invention; and

FIG. 3B is a diagram for describing a waveform of an output signal from a laser output detection circuit according to an embodiment of the present invention.

### DETAILED DESCRIPTION OF THE INVENTION

At least the following details will become apparent from descriptions of this specification and of the accompanying drawings.

At least the following details will become apparent from descriptions of this specification and of the attached drawings.

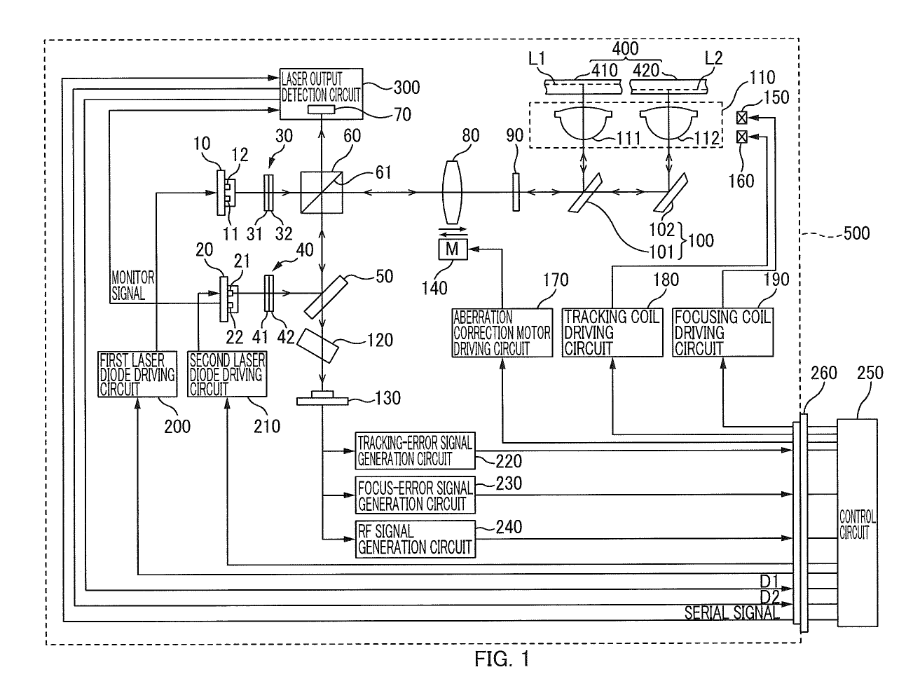

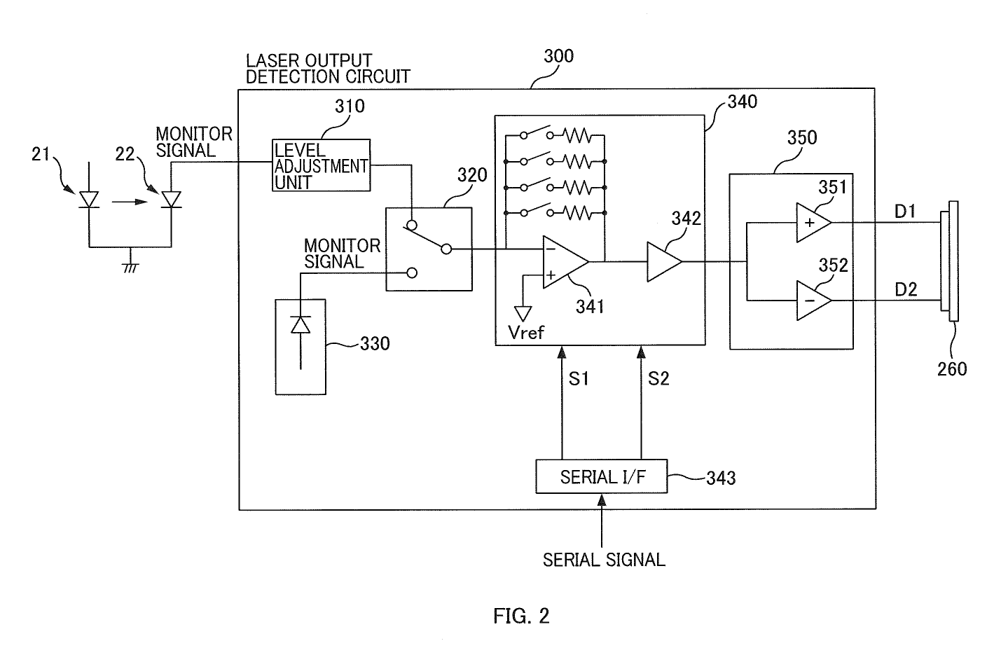

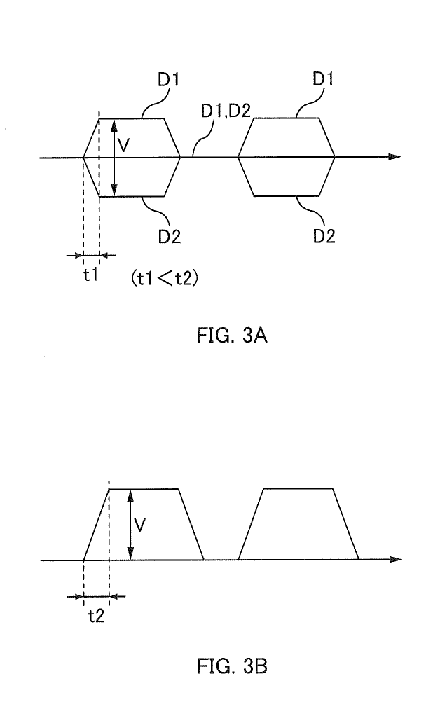

A configuration example of an optical pickup apparatus 500 according to an embodiment of the present invention will be described referring to FIGS. 1 to 3. FIG. 1 is a diagram illustrating the optical pickup apparatus 500 according to an embodiment of the present invention and a control circuit 250 configured to control constituent elements of the optical pickup apparatus 500. FIG. 2 is a configuration diagram of a laser output detection circuit 300 according to an embodiment of the present invention. FIGS. 3A and 3B are diagrams for describing a waveform of an output signal from the laser output detection circuit 300 according to an embodiment of the present invention.

The optical pickup apparatus 500 according to an embodiment of the present invention is configured so as to be capable of performing reading and recording of signals for each of optical discs 400 for DVD, CD and Blu-ray, for example, and have a function of performing recording/reproduction with respect to DVD and CD while have a function of performing reproduction with respect to Blu-ray.

==Recording/Reproduction with Respect to DVD or CD==

Recording/reproduction with respect to a DVD or CD standard optical disc 410 is performed as follows. Here, the optical disc 410 is an optical disc compatible with DVD or CD standard, and for simplicity's sake, the optical disc compatible with DVD or CD standard is collectively described as the optical disc 410.

Further, the description below will be made assuming that the optical disc 410 is a DVD, but the same applies when the optical disc 410 is a CD.

In FIG. 1, a first laser-beam generating apparatus 10 is a multi-laser unit capable of selectively radiating either one laser beam (first laser beam) of a laser beam for DVD which is red light having a wavelength of 650 nm and a laser beam for CD which is infrared light having a wavelength of 780 nm, for example. The first laser-beam generating apparatus 10 incorporates a DVD laser diode 11 configured to emit the laser beam for DVD and a CD laser diode 12 configured to emit the laser beam for CD.

The DVD laser diode 11 is configured to emit the DVD laser beam forward to the DVD standard optical disc 410. The DVD laser diode 11 is configured to emit the DVD laser beam having intensity according to a driving signal supplied from a first laser diode driving circuit 200.

Further, the CD laser diode 12 is configured to emit the CD laser beam forward to the CD standard optical disc 410. The CD laser diode 12 is configured to emit the CD laser beam having intensity according to the driving signal supplied from the first laser diode driving circuit 200.

A diffraction grating 30 includes a diffraction grating portion 31 and a half-wave plate 32.

The diffraction grating portion 31 is configured to split the laser beam into a main beam, which is zero order beam, and two sub-beams, which are plus first-order diffracted light and minus first-order diffracted light, when the DVD or CD laser beam (first laser beam) emitted forward to the optical disc 410 from the first laser-beam generating apparatus 10 enters the diffraction grating portion 31. The half-wave plate 32 is configured to convert the incident laser beam into linearly polarized light in an S direction, for example.

The laser beam having passed through the diffraction grating 30 enters a polarizing beam splitter 60, and the polarizing beam splitter 60 is configured to allow a portion of S-polarized laser beam (90% or more, for example) to pass through a control film 61 and reflect a remaining portion by the control film 61 (10% or less, for example), with respect to the red light having a wavelength of 650 nm and the infrared light having a wavelength of 780 nm. The polarizing beam splitter 60 also reflects a P-polarized laser beam.

The portion of the laser beam having passed through the polarizing beam splitter 60 is guided to a collimating lens 80, while the remaining portion of the laser beam reflected by the polarizing beam splitter 60 is guided, as first monitor light, to a front monitor diode 70 provided in the laser output detection circuit 300.

The intensity of the first monitor light, obtained by being reflected by the polarizing beam splitter 60 and guided to the front monitor diode 70, is changed with an output level of the laser beam emitted from the first laser-beam generating apparatus 10 to the optical disc 410.

The laser output detection circuit 300 is configured to receive the first monitor light guided to the front monitor diode 70, and generate a first monitor signal indicating the intensity of the received first monitor light, though the details will be described later. Then, the laser output detection circuit 300 is configured to amplify the first monitor signal generated by the front monitor diode 70 by a predetermined amplification factor, and thereafter output the result as a detection signal. Further, the laser output detection circuit 300 is connected to the control circuit 250 of the optical pickup apparatus 500 included in an optical disc drive through transmission paths D1 and D2 connected by a connector 260, and transmits the detection signal to the control circuit 250 through these transmission paths D1 and D2. The detection signal outputted from the laser output detection circuit 300 to the control circuit 250 is outputted as a differential signal using the two transmission paths D1 and D2.

The control circuit 250 outputs a control signal to the first laser diode driving circuit 200 on the basis of this detection signal so that the laser beam emitted from the first laser-beam generating apparatus 10 has intensity of a predetermined target value.

The first laser diode driving circuit 200 outputs a driving signal to the first laser-beam generating apparatus 10 in accordance with the control signal outputted from the control circuit 250. Then, the first laser-beam generating apparatus 10 outputs a laser beam having intensity according to the driving signal outputted from the first laser diode driving circuit 200.

As described above, it is possible to perform a laser servo operation for performing control so that the outputs of the DVD laser beam and the CD laser beam emitted from the first laser-beam generating apparatus 10 reach the target values.

The collimating lens 80 is configured to convert the laser beam from the polarizing beam splitter 60 into parallel light. The collimating lens 80 is configured to be capable of being displaced in an optical axis direction by an aberration correcting motor 140. A configuration is such that spherical aberration caused by a thickness of a protective layer of the optical disc 400 and the like can be corrected by an operation of displacing the collimating lens 80 in the optical axis direction.

A quarter-wave plate 90 is provided in a position where the laser beam, obtained by converting the laser light into parallel light by the collimating lens 80, is incident, and has a function of converting the incident laser beam from linearly polarized light into circularly polarized light, or to the contrary, from the circularly polarized light into the linearly polarized light.

A first raising mirror 101 is a semitransparent mirror having a surface thereof on which a wavelength-selective control film is formed, and is configured to allow the blue-violet light having a wavelength of 405 nm to pass therethrough and reflect the red light having a wavelength of 650 nm and the infrared light having a wavelength of 780 nm in a direction of a first objective lens 111.

In such a configuration, the red DVD laser beam having a wavelength of 650 nm or the infrared CD laser beam having a wavelength of 780 nm emitted from the first laser-beam generating apparatus 10 enters the first objective lens 111 via the diffraction grating 30, the polarizing beam splitter 60, the collimating lens 80, the quarter-wave plate 90, and the first raising mirror 101, and thereafter is applied as a spot to a signal recording layer L1 of the DVD- or CD-standard optical disc 410 by a light collecting operation of the first objective lens 111.

Return light reflected by the signal recording layer L1 of the optical disc 410 enters the control film 61 of the polarizing beam splitter 60 via the first objective lens 111, the first raising mirror 101, the quarter-wave plate 90, and the collimating lens 80.

The control film 61 of the polarizing beam splitter 60 has wavelength selectivity, and reflects the P-polarized light with respect to the red light having a wavelength of 650 nm and the infrared light having a wavelength of 780 nm. Since the return light incident onto the polarizing beam splitter 60 has been converted from S-polarized light to P-polarized light by reciprocating through the quarter-wave plate 90, the return light is reflected by the control film 61 of the polarizing beam splitter 60 and enters a semitransparent mirror 50.

Since the semitransparent mirror 50 is configured to allow the P-polarized light to pass therethrough, the return light incident onto the semitransparent mirror 50 passes through the semitransparent mirror 50.

The laser beam having been passed through the semitransparent mirror 50 passes through an astigmatism plate 120 arranged at an inclination so as to give astigmatism used for focusing control, and is guided to a photodetector 130.

The photodetector 130 is provided with a known quad sensor and the like. The photodetector 130 outputs an output signal from the quad sensor that has detected the return light of the laser beam to a tracking-error signal generation circuit 220, a focus-error signal generation circuit 230, and an RF signal generation circuit 240.

The tracking-error signal generation circuit 220 is configured to generate a tracking error signal for executing tracking control and output the signal to the control circuit 250 connected via the connector 260.

The focus-error signal generation circuit 230 is configured to generate a focus error signal for executing focusing control by an astigmatism method, and output the signal to the control circuit 250 which is connected via the connector 260.

The RF signal generation circuit 240 is configured to generate an RF signal associated with reading of a signal recorded on the signal recording layer L1 of the optical disc 410, and output the signal to the control circuit 250 which is connected via the connector 260.

Since a control operation for generating such various signals is known, the description thereof will be omitted.

The first objective lens 111 is fixed to a lens holding frame 110 together with a second objective lens 112.

The lens holding frame 110 is supported on a base (not shown) of the optical pickup apparatus using four or six supporting wires, for example, and is displaced in a perpendicular direction (focusing direction) with respect to the signal recording layer L1 of the optical disc 410 and a radial direction (tracking direction) of the optical disc 410 by a focusing coil 150 and a tracking coil 160, respectively.

The focusing coil 150 displaces the lens holding frame 110 in the focusing direction in concert with a magnet fixed to the base.

A focusing coil driving circuit 190 is connected to the control circuit 250 via the connector 260, and is configured such that a focus control signal outputted from the control circuit 250 on the basis of a focus error signal, which is outputted from the focus-error signal generation circuit 230, is inputted thereto, and a driving signal is supplied to the focusing coil 150.

The tracking coil 160 displaces the lens holding frame 110 in the tracking direction in concert with the magnet fixed to the base.

A tracking coil driving circuit 180 is connected to the control circuit 250 via the connector 260, and is configured such that a tracking control signal outputted from the control circuit 250 on the basis of a tracking error signal, which is outputted from the tracking-error signal generation circuit 220, is inputted thereto, and a driving signal is supplied to the tracking coil 160.

Since the focusing control and the tracking control in the optical pickup apparatus 500 incorporating the focusing coil 150 and the tracking coil 160 are known, the descriptions thereof will be omitted.

An aberration correction motor driving circuit 170 is connected to the control circuit 250 via the connector 260, and outputs a driving signal to an aberration correcting motor 140 in accordance with an aberration correction control signal outputted from the control circuit 250, and displaces the collimating lens 80 in an optical axis direction.

The control circuit 250 is connected to the various constituent elements of the optical pickup apparatus 500 via the connector 260, and when various signals outputted from the laser output detection circuit 300, the tracking-error signal generation circuit 220, the focus-error signal generation circuit 230, and the RF signal generation circuit 240 are inputted thereto, the control circuit 250 outputs a control signal to the first laser diode driving circuit 200, the aberration correction motor driving circuit 170, the tracking coil driving circuit 180, and the focusing coil driving circuit 190 on the basis of these signals.

In an embodiment of the present invention illustrated in FIG. 1, the driving circuits of the aberration correction motor driving circuit 170, the tracking coil driving circuit 180, and the focusing coil driving circuit 190, and the signal generation circuits of the tracking-error signal generation circuit 220, the focus-error signal generation circuit 230, and the RF signal generation circuit 240 are included in the optical pickup apparatus 500, however, in order to simplify the optical pickup apparatus 500 and based on the function of the control circuit 250, a configuration may be such that all or a part of the driving circuits and all or a part of the signal generation circuits are excluded from the optical pickup apparatus 500 and included in the control circuit 250. Such a configuration is also rational and preferable.

==Reproduction with Respect to Blu-ray==

Reproduction with respect to the optical disc 420 of the Blu-ray standard is performed as follows.

A second laser-beam generating apparatus 20 is configured to emit a laser beam (second laser beam) for Blu-ray which is a blue-violet light having a wavelength of 405 nm, for example. The second laser-beam generating apparatus 20 incorporates a Blu-ray laser diode 21 and a back-monitor photodetector 22.

The Blu-ray laser diode 21 is configured to emit the laser beam (second laser beam) compatible with the Blu-ray standard in a first direction toward the optical disc 420, and also emit a second monitor light in a second direction different from the first direction. The second laser-beam generating apparatus 20 is configured to emit the laser beam having intensity according to a driving signal supplied from a second laser diode driving circuit 210.

The back monitor photodetector 22 is a photosensor provided in a position where a second monitor light emitted from a Blu-ray laser diode 21 in the second direction is applied, and is configured to output a second monitor signal indicating intensity of the received second monitor light. Further, the optical pickup apparatus 500 according to an embodiment of the present invention is configured such that the second monitor signal outputted from the back monitor photodetector 22 is inputted not to the control circuit 250 but to the laser output detection circuit 300.

The second monitor signal inputted to the laser output detection circuit 300 is changed with an output level of the laser beam emitted from the Blu-ray laser diode 21.

The laser output detection circuit 300 is configured to amplify the second monitor signal inputted into the laser output detection circuit 300 by a predetermined amplification factor, and thereafter output the result as a detection signal. This detection signal is outputted to the control circuit 250 connected via the connector 260. Though the details will be described later, the detection signal outputted from the laser output detection circuit 300 to the control circuit 250 is outputted as a differential signal through the two transmission paths D1 and D2.

The control circuit 250 is configured to output a control signal to the second laser diode driving circuit 210 so that the intensity of the laser beam (second laser beam) emitted from the Blu-ray laser diode 21 reaches a predetermined target value on the basis of this detection signal.

The second laser diode driving circuit 210 is configured to output a driving signal to the second laser-beam generating apparatus 20 in accordance with the control signal outputted from the control circuit 250. Then, the Blu-ray laser diode 21 outputs the laser beam having intensity according to the driving signal outputted from the second laser diode driving circuit 210.

As such, it is possible to perform a laser servo operation of performing control so that the output of the laser beam emitted from the Blu-ray laser diode 21 reaches the target value.

A diffracting grating 40 includes a diffracting grating portion 41 and a half-wave plate 42.

The diffracting grating portion 41 is configured to split the laser beam into a main beam which is zero order beam and two sub-beams, which are plus first-order diffracted beam and minus first-order diffracted beam, when the laser beam emitted from the Blu-ray laser diode 21 toward the optical disc 420 enters the diffracting grating portion 41. The half-wave plate 42 is configured to change linearly polarized light in direction of the incident laser beam emitted from the Blu-ray laser diode 21 so as to become a linear polarized light beam in the S direction with respect to the polarizing beam splitter 60.

The semitransparent mirror 50 is configured to reflect a portion of the laser beam such as 50% of the laser beam, and allow a portion of the laser beam such as 50% of the laser beam to pass therethrough.

The laser beam reflected by the semitransparent mirror 50 enters the polarizing beam splitter 60 and the blue-violet laser beam having a wavelength of 405 nm is reflected by the control film 61 having wavelength selectivity.

The collimating lens 80 is configured to covert the laser beam from the polarizing beam splitter 60 into parallel light. The collimating lens 80 is configured to be capable of being displaced in the optical axis direction by an aberration correcting motor 140. A configuration is such that spherical aberration caused by a thickness of a protective layer of the optical disc 400 and the like is corrected by an operation of displacing the collimating lens 80 in the optical axis direction.

The quarter-wave plate 90 is provided in a position where the laser beam, obtained by converting the laser light into the parallel light by the collimating lens 80, is incident, and has a function of converting the incident laser beam from linearly polarized light into circularly polarized light, or to the contrary, from the circularly polarized light into the linearly polarized light.

The first raising mirror 101 is a semitransparent mirror having a surface thereof on which a wavelength-selective control film is formed, and is configured to allow the blue-violet light having a wavelength of 405 nm to pass therethrough and reflect the red light having a wavelength of 650 nm and the infrared light having a wavelength of 780 nm in the direction of a first objective lens 111.

A second raising mirror 102 is provided in a position where the blue-violet laser beam having passed through the first raising mirror 101 is incident and is configured to reflect the incident laser beam in a direction of the second objective lens 112.

In such a configuration, the blue-violet laser beam having a wavelength of 405 nm emitted from the Blur-ray laser diode 21 enters the second objective lens 112 via the diffraction grating 40, the semitransparent mirror 50, the polarizing beam splitter 60, the collimating lens 80, the quarter-wave plate 90, the first raising mirror 101, and the second raising mirror 102, and thereafter is applied as a spot to a signal recording layer L2 of the Blu-ray standard optical disc 420 by a light collecting operation of the second objective lens 112.

Return light reflected by the signal recording layer L2 of the optical disc 420 enters the control film 61 of the polarizing beam splitter 60 via the second objective lens 112, the second raising mirror 102, the first raising mirror 101, the quarter-wave plate 90, and the collimating lens 80.

The control film 61 of the polarizing beam splitter 60 has wavelength selectivity, and reflects the blue-violet light having a wavelength of 405 nm, and such reflected light is incident onto the semitransparent mirror 50.

Since the laser beam incident onto the semitransparent mirror 50 has been converted from S-polarized light to P-polarized light by reciprocating through the quarter-wave plate 90, the laser beam is allowed to pass through the semitransparent mirror 50.

The laser beam having passed through the semitransparent mirror 50 is allowed to pass through the astigmatism plate 120 arranged at an inclination so as to give astigmatism used for the focusing control, and is guided to the photodetector 130.

Subsequently, similarly to the cases of DVD and CD, the output signals from the quad sensor provided in the photodetector 130 is outputted to the tracking-error signal generation circuit 220, the focus-error signal generation circuit 230, and the RF signal generation circuit 240.

Then, the tracking error signal is outputted from the tracking-error signal generation circuit 220 to the control circuit 250, the focus error signal is outputted from the focus-error signal generation circuit 230 to the control circuit 250, and the RF signal is outputted from the RF signal generation circuit 240 to the control circuit 250.

Then, from the control circuit 250, control signals are outputted to the focusing coil driving circuit 190, the tracking coil driving circuit 180, the aberration correction motor driving circuit 170, and the second laser diode driving circuit 210, respectively.

### ==Laser Output Detection Circuit==

Subsequently, the laser output detection circuit 300 according to an embodiment of the present invention will be described referring to FIGS. 2 and 3.

The laser output detection circuit 300 includes, as illustrated in FIG. 2, a front monitor photodetector 330, a level adjustment unit 310, a monitor signal selection unit 320, a signal amplifier unit 340, a signal output unit (signal transmission unit, a differential signal conversion unit) 350, and a serial I/F 343.

The front monitor photodetector 330 corresponds to the front monitor diode 70, which is a photo sensor for receiving the first monitor light obtained by being reflected by the polarizing beam splitter 60 and guided thereto, among the DVD-standard or CD-standard laser beam (first laser beam) emitted from the first laser beam generating apparatus 10 to the optical disc 410. The front monitor photodetector 330 outputs a first monitor signal having a current value according to the intensity of the received first monitor light.

The level adjustment unit 310 is configured to amplify a second monitor signal so that a range between the maximum value and the minimum value of a current of the second monitor signal outputted from the back monitor photodetector 22 is matched with a range between the maximum value and the minimum value of a current of the first monitor signal outputted from the front monitor photodetector 330.

The range of the current of the second monitor signal outputted from the back monitor photodetector 22 becomes lower than the range of the current of the first monitor signal outputted from the front monitor photodetector 330 when the required linearity range is secured, and thus the level adjustment unit 310 amplify the current of the second monitor signal outputted from the back monitor photodetector 22, so that the range of the current of this second monitor signal is matched with the range of the first monitor signal according to the intensity of the DVD-standard or CD-standard laser beam outputted from the front monitor photodetector 330.

This enables commonality of receiving circuits between the first monitor signal outputted from the front monitor photodetector 330 incorporated in the laser output detection circuit 300 and the second monitor signal outputted from the back monitor photodetector 22 outside the laser output detection circuit 300 in the control circuit 250.

The monitor signal selection unit 320 is configured to select the first monitor signal from the front monitor photodetector 330 when the optical disc drive enters an operating state where information is recorded or reproduced with respect to DVD or CD and when an identification signal in a state of a serial signal indicative of the operating state of the optical disc drive is transmitted from the control circuit 250; and the monitor signal selection unit 320 is configured to switch and select the second monitor signal from the level adjustment unit 310 when the optical disc drive enters an operating state where information is reproduced with respect to Blu-ray and when an identification signal in a state of a serial signal indicative of the operating state of the optical disc drive is transmitted from the control circuit 250.

The optical pickup apparatus 500 emits the DVD laser beam or the CD laser beam from the first laser beam generating apparatus 10 when recording or reproduction of information is performed with respect to DVD or CD, and emits the Blu-ray laser beam from the second laser beam generating apparatus 20 when reproduction of information is performed with respect to Blu-ray. Thus, the first monitor signal and the second monitor signal are not inputted to the monitor signal selection unit 320 concurrently.

As such, the monitor signal selection unit 320 can select the first monitor signal when recording or reading of information is performed with respect to the optical disc 410, and can select the second monitor signal when reading is performed with respect to the optical disc 420.

The signal amplifier unit 340 is configured to amplify the first monitor signal or the second monitor signal selected by the monitor signal selection unit 320 in accordance with the amplification factor designated by a serial signal transmitted from the control circuit 250.

The signal amplifier unit 340 includes a first amplifier unit 341 and a second amplifier unit 342. The first monitor signal or the second monitor signal selected by the monitor signal selection unit 320 is amplified by the first amplifier unit 341, and thereafter, further amplified by the second amplifier unit 342. Each of the amplification factor (first amplification factor) in the first amplifier unit 341 and the amplification factor (second amplification factor) in the second amplifier unit 342 is designated by the serial signal.

The first amplification factor is set at the time of manufacture of the optical pickup apparatus 500, for example, so as to offset variation in characteristics of the front monitor photodetector 330, the back monitor photodetector 22 and the like.

The second amplification factor is set so as to offset a change in the ranges of the currents of the first monitor signal and the second monitor signal caused by a change in the intensity of the laser beam generated during the operation of the optical pickup apparatus 500, such as a difference in the type of the optical disc 400 (DVD, CD, and Blu-ray) into/from which information is recorded/reproduced, a difference in the intensity of the laser beam between recording and reproduction of the information and the like.

The first monitor signal or the second monitor signal selected by the monitor signal selection unit 320 is amplified by the first amplifier unit 341, and thereafter amplified by the second amplifier unit 342 by the second amplification factor, thereby being able to reduce amounts of changes in the ranges of currents of the first monitor signal and the second monitor signal transmitted to the control circuit 250.

As a result, the fluctuation in the range of the current of the first monitor light or the second monitor light can be suppressed in spite of variation in the characteristics of the front monitor photodetector 330, the back monitor photodetector 22 and the like, change in intensity of the laser beam during the operation of the optical pickup apparatus 500, and the like, thereby enabling commonality of receiving circuits between the first monitor signal and the second monitor signal in the control circuit 250.

The serial I/F 343 is configured to receive a serial signal transmitted from the control circuit 250, and take out information indicating the amplification factor in the signal amplifier unit 340 from the serial signal. The information indicating the amplification factor includes the amplification factor in the first amplifier unit 341 and the amplification factor in the second amplifier unit 342.

The information indicating the amplification factor is taken out as 8-bit digital data, for example, from the serial signal, and the amplification factor of the first amplifier unit 341 is designated by higher 4 bits (S1) thereof and the amplification factor in the second amplifier unit 341 is designated by lower 4 bits (S2).

The amplification factor of the first amplifier unit 341 is set by a combination of four feedback resistors, for example. On/off of switches, which are connected in series to the four feedback resistors, respectively, is designated by respective bits in a 4 bit signal S1 contained in the serial signal. Further, the amplification factor of the second amplifier unit 342 is set such that 16 values are set in advance in a selectable manner, for example, and the amplification factor is set by selecting any of these 16 values in response to a 4-bit signal S2.

As such, the monitor signals are amplified separately by the first amplifier unit 341 and the second amplifier unit 342, thereby being able to amplify the first monitor signal and the second monitor signal to have appropriate voltages, the first and second monitor signals corresponding to the laser beams generated in the various operating states of the optical disc drives that are brought about depending on the rotation speed, recording/reproduction, etc., with respect to the disc; and being able to transmit the amplified monitor signals to the control circuit 250. Further, it becomes possible to realize a high amplification factor in the signal amplifier unit 340 as a whole.

The signal output unit 350 is configured to output the monitor signal amplified by the signal amplifier unit 340 as a detection signal. The signal output unit 350 includes a first output circuit 351 and a second output circuit 352, and is configured to convert the monitor signal into a differential signal constituted by a non-inverting signal and an inverting signal, and output this differential signal as the detection signal. The signal output unit 350 is configured to transmit the non-inverting signal to the control circuit 250 via the first transmission path D1, and transmit the inverting signal to the control circuit 250 via the second transmission path D2.

The first output circuit 351 is configured to generate the non-inverting signal from the monitor signal amplified by the signal amplifier unit 340, and output the non-inverting signal to the first transmission path D1. The second output circuit 352 is configured to generate the inverting signal from the monitor signal amplified by the signal amplifier unit 340 and output the inverting signal to the second transmission path D2.

A state in which the detection signal is outputted as a differential signal to the first transmission path D1 and the second transmission path D2 is illustrated in FIG. 3A. Further, a waveform example when the detection signal is outputted as a single-end signal is illustrated for comparison in FIG. 3B.

As illustrated in FIGS. 3A and 3B, by outputting the detection signal as the differential signal, a time period t1 required until the voltage of the detection signal reaches V from 0 can be reduced as compared with a time period t2 required when the signal is outputted as a single-end signal.

Thus, since transmission of a signal between the laser output detection circuit 300 and the control circuit 250 can be expedited, the feedback control of the intensity of the laser beam emitted from the first laser-beam generating apparatus 10 or the second laser-beam generating apparatus 20 can be expedited.

An embodiment of the present invention has been described, and according to the optical pickup apparatus 500 according to an embodiment of the present invention, the first monitor signal indicating the intensity of the first laser beam having a wavelength for DVD or CD (first wavelength) emitted from the first laser-beam generating apparatus 10 and the second monitor signal indicating the intensity of the second laser beam having the second wavelength for Blu-ray, which is different from the first wavelength, emitted from the second laser-beam generating apparatus 20 are transmitted to the control circuit 250 through the common transmission path, thereby being able to reduce the number of transmission paths between the optical pickup apparatus 500 and the control circuit 250.

Further, when the first monitor signal and the second monitor signal are transmitted to the control circuit 250 via the common transmission path, the second monitor signal is amplified by the level adjustment unit 310 with the predetermined amplification factor, thereby being able to match the range of the current of the first monitor signal with the range of the current of the second monitor signal. As a result, when information is recorded or reproduced with respect to the optical discs 410 and 420 of different types, for example, even if the intensities of the optimal laser beams are different from each other therebetween, the first monitor signal and the second monitor signal can be transmitted to the control circuit 250 via the common transmission path. The control circuit 250 enables commonality of the receiving circuit for the first monitor signal and the receiving circuit for the second monitor signal.

Further, the first monitor signal or the second monitor signal is converted into a differential signal including a non-inverting signal and an inverting signal and then the differential signal is transmitted from the optical pickup apparatus 500 to the control circuit 250, thereby being able to expedite transmission of the first monitor signal or the second monitor signal to the control circuit 250.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a first laser light source configured to emit a first laser beam to a first optical disc to which the first laser beam having a first wavelength conforms;
a first photodetector configured to detect intensity of the first laser beam emitted from the first laser light source and output a first monitor signal indicative of intensity of the first laser beam;
a second laser light source configured to emit—a second laser beam to a second optical disc to which the second laser beam having a second wavelength different from the first wavelength conforms;
a second photodetector configured to detect intensity of the second laser beam emitted from the second laser light source and output a second monitor signal indicative of intensity of the second laser beam;
a signal selection unit configured to select the first monitor signal when recording or reading of information is performed for the first optical disc, and select the second monitor signal when recording or reading of information is performed for the second optical disc; and
a signal transmission unit configured to transmit, via a common transmission path, the first monitor signal or the second monitor signal selected by the single selection unit to a control circuit configured to control intensity of the first laser beam emitted from the first laser light source and the second laser beam emitted from the second laser light source.

2. The optical pickup apparatus according to claim 1, further comprising:
a level adjustment unit configured to amplify the second monitor signal by a predetermined amplification factor so that a range between a maximum value and a minimum value of a current of the second monitor signal outputted from the second photodetector is matched with a range between a maximum value and a minimum value of a current of the first monitor signal, wherein
the signal selection unit is configured to select the first monitor signal outputted from the first photodetector when recording or reading of information is performed for the first optical disc, and select the second monitor signal amplified by the level adjustment unit, when recording or reading of information is performed for the second optical disc.

3. The optical pickup apparatus according to claim 1, further comprising:
a signal amplifier unit configured to amplify the first monitor signal or the second monitor signal selected by the signal selection unit, by a predetermined amplification factor, wherein
the signal transmission unit is configured to transmit, via the common transmission path, the first monitor signal or the second monitor signal amplified by the signal amplifier unit to the control circuit.

4. The optical pickup apparatus according to claim 3, wherein
the signal amplifier unit includes
a first amplifier unit configured to amplify the first monitor signal or the second monitor signal selected by the signal selection unit, by a first amplification factor, and
a second amplifier unit configured to further amplify the first monitor signal or the second monitor signal amplified by the first amplifier unit, by a second amplification factor.

5. The optical pickup apparatus according to claim 1, further comprising:
a differential signal conversion unit configured to convert the first monitor signal or the second monitor signal transmitted to the control circuit into a differential signal constituted by a non-inverting signal and an inverting signal, wherein
the common transmission path includes a first transmission path and a second transmission path; and
the signal transmission unit is configured to transmit the non-inverting signal to the control circuit via the first transmission path, and transmit the inverting signal to the control circuit via the second transmission path.

6. The optical pickup apparatus according to claim 1, further comprising:
a beam splitter configured to split a portion of the first laser beam emitted to the first optical disc as first monitor light, wherein
the first photodetector is configured to detect intensity of the first monitor light and output the first monitor signal indicative of intensity of the first laser beam;
the second laser light source is configured to emit the second laser beam in a first direction toward the second optical disc, as well as emit the second laser beam in a second direction different from the first direction as second monitor light; and
the second photodetector is configured to detect intensity of the second monitor light and output the second monitor signal indicative of intensity of the second laser beam.
